(19) United States
(12) Patent Application Publication
(10) Pub. No.: US 2024/0359482 A1
(43) Pub. Date: Oct. 31, 2024

(54) IMAGE FORMING APPARATUS

(71) Applicant: KYOCERA Document Solutions Inc., Osaka (JP)

(72) Inventors: Masato Usui, Osaka (JP); Hiroomi Nakatsuji, Osaka (JP); Naoko Kawashima, Osaka (JP); Jun Nakano, Osaka (JP)

(21) Appl. No.: 18/641,301

(22) Filed: Apr. 19, 2024

(30) Foreign Application Priority Data
Apr. 27, 2023 (JP) 2023-072908

(51) Int. Cl. B41J 2/21; B41J 2/045

(52) U.S. Cl. CPC B41J 2/2139; B41J 2/0451; B41J 2/04586; B41J 2/2142

(57) ABSTRACT

An image forming apparatus includes a recording head, a control unit, and a correction processing unit. The recording head is configured to eject ink corresponding to an image to be printed, using arranged nozzles. The control unit is configured to determine nozzles corresponding to the image to be printed, correspondingly to a position of a print sheet, and cause the recording head to eject ink from the nozzles. The correction processing unit is configured to detect an ejection malfunction nozzle and perform a correction process corresponding to the ejection malfunction nozzles. Further, if the number of the detected ejection malfunction nozzles exceeds a predetermined upperlimit value, the correction processing unit preferentially sets as a target of the correction process an ejection malfunction nozzle that ejects an ink droplet earlier than nozzles corresponding to two adjacent dots of a dot corresponding to the ejection malfunction nozzle.

### CROSS-REFERENCE TO RELATED APPLICATIONS

This application relates to and claims priority rights from Japanese Patent Application No. 2023-072908, filed on Apr. 27, 2023, the entire disclosures of which are hereby incorporated by reference herein.

### BACKGROUND

### 1. Field of the Present Disclosure

The present disclosure relates to an image forming apparatus.

### 2. Description of the Related Art

An inkjet-type image forming apparatus detects a malfunction nozzle that becomes unable to properly eject ink, among nozzles that eject ink in a recording head, and changes an ink ejection amount for an adjacent dot on the basis of an occurrence status of the malfunction nozzle.

If a value obtained by quantifying a malfunction degree of an ejection malfunction nozzle exceeds a non-ejection threshold value, then another inkjet-type image forming apparatus prohibits the ejection malfunction nozzle from ejecting ink, and changes the non-ejection threshold value correspondingly to an ejection order between an adjacent nozzle of the ejection malfunction nozzle and a nozzle adjacent of the adjacent nozzle. Further, in the image forming apparatus, if the adjacent nozzle to the ejection malfunction nozzle is a late ejection nozzle in the ejection order, then for this ejection malfunction nozzle (i.e. a nozzle that ejects ink earlier than the adjacent nozzle), a supplementing process performed by the adjacent nozzle is not performed.

When printing on a cut sheet, a nozzle used to depict each pixel in an image to be printed is differently determined sheet by sheet on the basis of a sheet transportation condition and correspondingly to a position (i.e. a position in a direction perpendicular to a transportation direction) of an incoming sheet in transportation. As mentioned, if the ink ejection amount is corrected due to the malfunction nozzle, then in a short time from determination of the sheet position to ink ejection, it is required to determine a pixel corresponding to the malfunction nozzle in the image to be printed and to perform a correction process for a periphery of the determined pixel.

Therefore, if many ink ejection malfunction positions appear to be corrected, the aforementioned correction process can not be completed in the short time. Although such many ink ejection malfunction positions can be corrected by performing the correction process using high-speed hardware, such high-speed hardware results in a high cost of the apparatus.

In the aforementioned image forming apparatus, if the ejection malfunction nozzle is an earlier ejection nozzle than the adjacent nozzle, then for this ejection malfunction nozzle the supplementing process is not performed. However, it is not favorable due to the following reason. If droplet coalescence occurs in which an ink droplet of late ejection coalesces with a dot formed on a print sheet by early ejection (i.e. with an early ejection dot), then the ink droplet of late ejection is pulled by the early ejection dot and consequently a position of a dot formed by the late ejection (i.e. late ejection dot) is affected by a position of the early ejection dot. Therefore, when ejection deviation (i.e. deviation of a droplet hitting position) occurs on the early ejection dot, then a blank line tends to occur because the late ejection dot is also pulled to a direction of the ejection deviation.

### SUMMARY

An image forming apparatus according to an aspect of the present disclosure includes a recording head, a control unit, and a correction processing unit. The recording head is configured to eject ink corresponding to an image to be printed, using arranged nozzles. The control unit is configured to determine nozzles corresponding to the image to be printed, correspondingly to a position of a print sheet, and cause the recording head to eject ink from the nozzles. The correction processing unit is configured to detect an ejection malfunction nozzle perform and a correction process corresponding to the ejection malfunction nozzles. Further, if the number of the detected ejection malfunction nozzles exceeds a predetermined upperlimit value, the correction processing unit preferentially sets as a target of the correction process an ejection malfunction nozzle that ejects an ink droplet earlier than nozzles corresponding to two adjacent dots of a dot corresponding to the ejection malfunction nozzle.

These and other objects, features and advantages of the present disclosure will become more apparent upon reading of the following detailed description along with the accompanied drawings.

### BRIEF DESCRIPTION OF THE DRAWINGS

FIG. 1 shows a side view that indicates an internal mechanical configuration of an image forming apparatus in an embodiment according to the present disclosure;

FIG. 2 shows a plane view of an example of recording heads 1a to 1d in the image forming apparatus 10 shown in FIG. 1;

FIG. 3 shows a diagram that explains nozzles in the recording heads 1a to 1d shown in FIG. 2;

FIG. 4 shows a block diagram that indicates an electronic configuration of the image forming apparatus 10 in the embodiment according to the present disclosure;

FIG. 5 shows a diagram that explains a difference of an occurrence degree of droplet coalescence due to ejection order; and

FIG. 6 shows a flowchart that explains a setting of an ejection malfunction nozzle as a target of a correction process in the image forming apparatus 10 shown in FIGS. 1 to 3.

### DETAILED DESCRIPTION

Hereinafter, an embodiment according to an aspect of the present disclosure will be explained with reference to drawings.

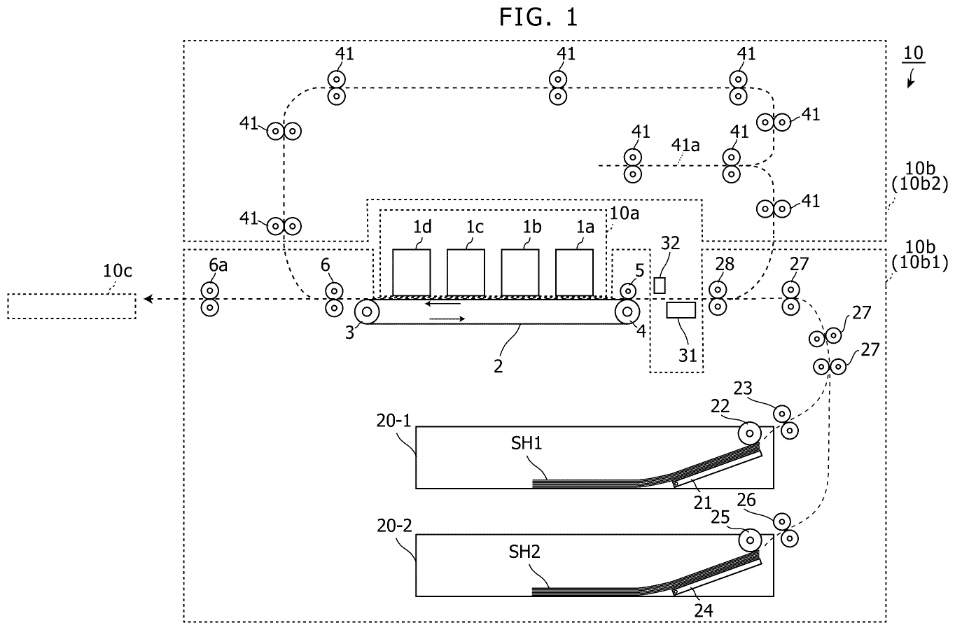

FIG. 1 shows a side view that indicates an internal mechanical configuration of an image forming apparatus in an embodiment according to the present disclosure. The image forming apparatus 10 in this embodiment is an apparatus such as printer, copier, facsimile machine or multi function peripheral.

The image forming apparatus 10 shown in FIG. 1 includes a print engine 10a and a sheet transportation unit 10b. The print engine 10a physically forms an image to be printed on a print sheet (print paper sheet or the like). In this embodiment, the print engine 10a is a line-type inkjet print engine.

In this embodiment, the print engine 10a includes line-type head units 1a to 1d corresponding to four ink colors: Cyan, Magenta, Yellow, and Black.

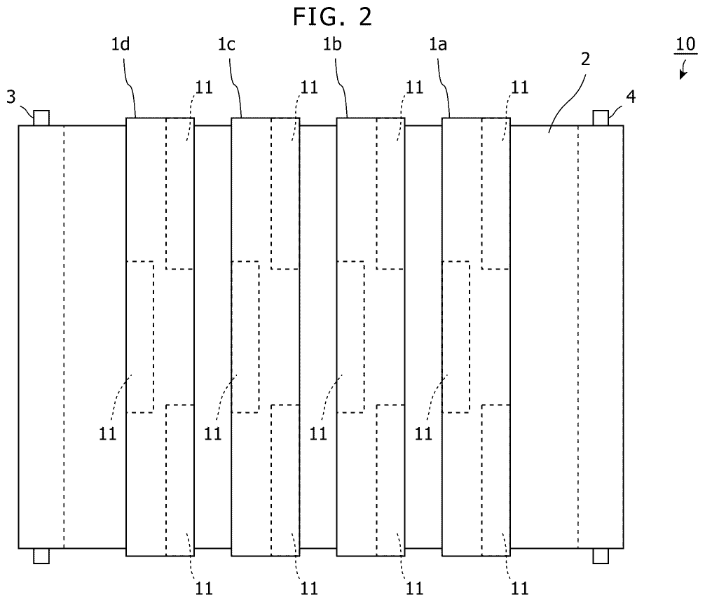

FIG. 2 shows a plane view of an example of recording heads 1a to 1d in the image forming apparatus 10 shown in FIG. 1. As shown in FIG. 2, for example, in this embodiment, each of the inkjet recording units 1a, 1b, 1c and 1d includes plural (here, three) head units 11. The head units 11 are arranged along a primary scanning direction, and are capable of being mounted to and demounted from a main body of the image forming apparatus. Each of the recording heads 1a, 1b, 1c and 1d may include only one head unit 11. The head unit 11 of the inkjet recording unit 1a, 1b, 1c or 1d includes 2-dimensionally arranged nozzles, and ejects ink corresponding to the image to be printed using the nozzles.

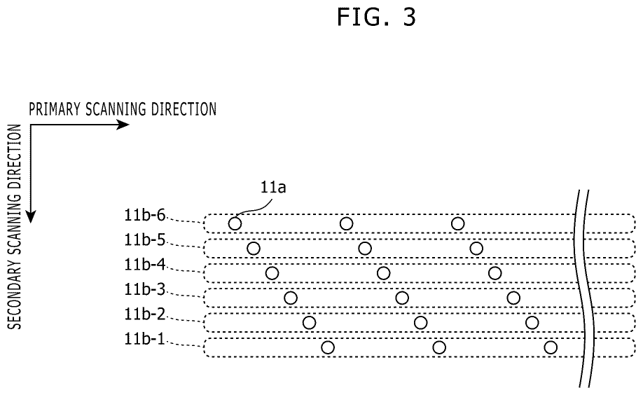

FIG. 3 shows a diagram that explains nozzles in the recording heads 1a to 1d shown in FIG. 2. For example, as shown in FIG. 3, the head unit 11 of each recording head 1a, 1b, 1c or 1d includes plural nozzle arrays 11b-1 to 11b-6. Here, each of the nozzle array 11b-i (i=1, . . . , 6) includes nozzles 11a arranged with a predetermined interval along a primary scanning direction. In each of the nozzle array 11b-i, the nozzles 11a are arranged with an offset in the primary scanning direction such that the nozzles 11a are arranged with a constant interval in the primary scanning direction.

When a certain position of a print sheet in a secondary scanning direction (i.e. transportation direction) passes at a position of a nozzle array 11b-i, an ink droplet is ejected from a nozzle 11a of the nozzle array 11b-i (i.e. from early ejection nozzles); and afterward, when this position of the print sheet passes at a position of another nozzle array 11b-j, an ink droplet is ejected from a nozzle 11a of the nozzle array 11b-j (i.e. from late ejection nozzles). Therefore, between dots formed with the early-ejected ink droplets (i.e. between early ejection dots), formed is a dot formed with the late-ejected ink droplet (late ejection dot).

Here, there are the following three ejection orders on dot arrangement in the primary scanning direction.
(Ejection order #1) a target dot (a dot position corresponding to a target nozzle) is an early ejection dot and two adjacent dots of the target dot are late ejection dots.
(Ejection order #2) a target dot is a late ejection dot and two adjacent dots of the target dot are early ejection dots.
(Ejection order #3) a target dot is an early ejection dot for one of two adjacent dots of the target dot but the target dot is a late ejection dot for the other of the two adjacent dots.

Returning to FIG. 1, the sheet transportation unit 10b transports the print sheet to the print engine 10a along a predetermined transportation path, and transports the print sheet after printing from the print engine 10a to a predetermined output destination (here, an output tray 10c or the like).

The sheet transportation unit 10b includes a main sheet transportation unit 10b1 and a circulation sheet transportation unit 10b2. In duplex printing, the main sheet transportation unit 10b1 transports to the print engine 10a a print sheet to be used for printing of a first-surface page image, and the circulation sheet transportation unit 10b2 transports the print sheet from a posterior stage of the print engine 10a to a prior stage of the print engine 10a with detaining a predetermined number of print sheets.

In this embodiment, the main sheet transportation unit 10b1 includes (a) a circular-type transportation belt 2 that is arranged so as to be opposite to the print engine 10a and transports a print sheet, (b) a driving roller 3 and a driven roller 4 around which the transportation belt 2 is hitched, (c) a nipping roller 5 that nips the print sheet with the transportation belt 2, and (d) output roller pairs 6 and 6a.

The driving roller 3 and the driven roller 4 rotate the transportation belt 2. The nipping roller 5 nips an incoming print sheet transported from a sheet feeding cassette 20-1 or 20-2 mentioned below, and the nipped print sheet is transported by the transportation belt 2 to printing positions of the inkjet recording units 1a to 1d in turn, and on the print sheet, images of respective colors are printed by the inkjet recording units 1a to 1d. Subsequently, after the color printing, the print sheet is outputted by the output roller pairs 6 and 6a to an output tray 10c or the like.

Further, the main sheet transportation unit 10b1 includes plural sheet feeding cassettes 20-1 and 20-2. The sheet feeding cassettes 20-1 and 20-2 store print sheets SH1 and SH2, and push up the print sheets SH1 and SH2 using lift plates 21 and 24 so as to cause the print sheets SH1 and SH2 to contact with pickup rollers 22 and 25, respectively. The print sheets SH1 and SH2 put on the sheet feeding cassettes 20-1 and 20-2 are picked up to sheet feeding rollers 23 and 26 by the pickup rollers 22 and 25 sheet by sheet from the upper sides, respectively. The sheet feeding rollers 23 and 26 are rollers that transport the print sheets SH1 and SH2 sheet by sheet fed by the pickup rollers 22 and 25 from the sheet feeding cassettes 20-1 and 20-2 onto a transportation path. A transportation roller 27 is a transportation roller on the transportation path common to the print sheets SH1 and SH2 transported from the sheet feeding cassettes 20-1 and 20-2.

When performing duplex printing, the circulation sheet transportation unit 10b2 returns the print sheet from a predetermined position in a downstream side of the print engine 10a to a predetermined position in an upstream side of the print engine 10a (here, to a predetermined position in an upstream side of a line sensor 31 mentioned below). The circulation sheet 10b2 transportation unit includes a transportation roller 41, and a switch back transportation path 41a that reverses a movement direction of the print sheet in order to change a surface that should face the print engine 10a among surfaces of the print sheet from the first surface to the second surface of the print sheet.

Further, the image forming apparatus 10 includes a line sensor 31 and a sheet detecting sensor 32.

The line sensor 31 is an optical sensor that is arranged along a direction perpendicular to a transportation direction of the print sheet, and detects positions of both end edges (both side edges) of the print sheet. For example, the line sensor 31 is a CIS (Contact Image Sensor). In this embodiment, the line sensor 31 is arranged at a position between the registration roller 28 and the print engine 10a.

The sheet detecting sensor 32 is an optical sensor that detects that a front end of the print sheet SH1 or SH2 passes through a predetermined position on the transportation path. The line sensor 31 detects the positions of the both side end edges at a time point that the front end of the print sheet SH1 or SH2 is detected by the sheet detecting sensor 32.

For example, as shown in FIG. 1, the print engine 10a is arranged in one of an upward part of the transportation path and a downward part of the transportation path (here, in the upward part); the line sensor 31 is arranged in the other of the upward part of the transportation path and the downward part of the transportation path (here, in the downward part); and the circulation transportation unit 10b2 transports the print sheet from the downstream side of the print engine 10a to the upstream side of the line sensor 31 with changing an orientation of the print sheet in a switch back manner.

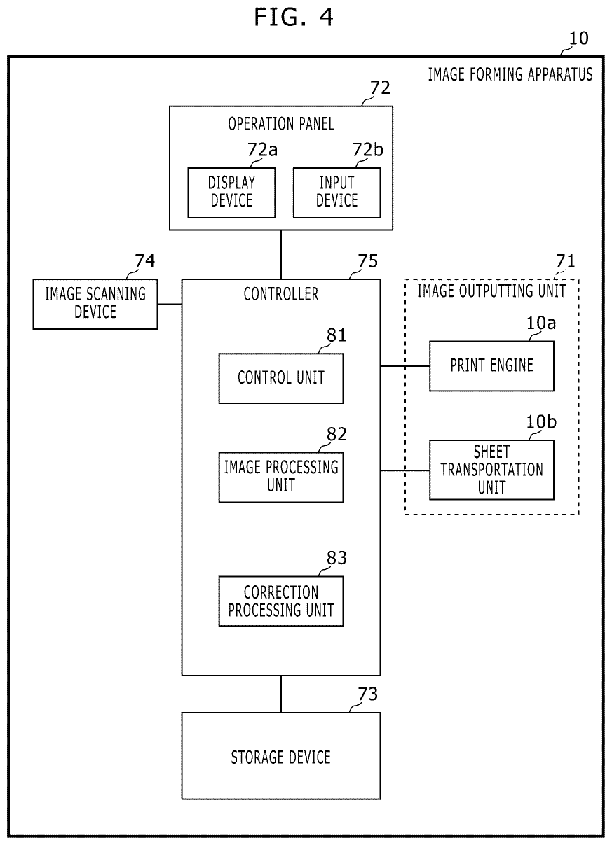

FIG. 4 shows a block diagram that indicates an electronic configuration of the image forming apparatus 10 in the embodiment according to the present disclosure. As shown in FIG. 4, the image forming apparatus 10 includes not only an image outputting unit 71 that includes the mechanical configuration shown in FIGS. 1 to 3 but an operation panel 72, a storage device 73, an image scanning device 74, and a controller 75.

The operation panel 72 is arranged on a housing surface of the image forming apparatus 10, and includes a display device 72a such as a liquid crystal display and an input device 72b such as a hard key and/or a touch panel, and displays sorts of messages for a user using the display device 72a and receives a user operation using the input device 72b.

The storage device 73 is a non-volatile storage device (flash memory, hard disk drive or the like) in which data, a program and the like have been stored that are required for control of the image forming apparatus 10.

The image scanning device 74 includes a platen glass and an auto document feeder, and optically scans a document image from a document put on the platen glass or a document fed by the auto document feeder, and generates image data of the document image.

The controller 75 includes a computer that performs a software process in accordance with a program, an ASIC (Application Specific Integrated Circuit) that performs a predetermined hardware process, and/or the like, and acts as sorts of processing units using the computer, the ASIC and/or the like. This computer includes a CPU (Central Processing Unit), a ROM (Read Only Memory), a RAM (Random Access Memory) and the like, and loads a program stored in the storage device 73, the ROM or the like to the RAM and executes the program using the CPU and thereby acts as processing units (with the ASIC if required). Here, the controller 75 acts as a control unit 81, an image processing unit 82, and a correction processing unit 83.

The control unit 81 controls the image outputting unit 71 (the print engine 10a, the sheet transportation unit 10b and the like), and thereby performs a print job requested by a user. In this embodiment, the control unit 81 causes the image processing unit 82 to perform a predetermined image process, and controls the print engine 10a (the head units 11) and causes the head units 11 to eject ink and thereby forms a print image on a print sheet. The image processing unit 82 performs a predetermined image process such as RIP (Raster Image Processing), color conversion, halftoning and/or the like for image data of a printing image.

Specifically, the control unit 81 causes the print engine 10a to print a user document image based on printing image data specified by a user.

Further, in this embodiment, the control unit 81 has an automatic centering function that (a) determines as an actual sheet center position a center position of a print sheet on the basis of the positions of both side end edges of the print sheet detected by the line sensor 31, and (b) adjusts a center position of an image to be printed, on the basis of a difference from the actual sheet center position, and performs the automatic centering function as a hardware process.

Specifically, in the automatic centering function, the control unit 81 changes a depicting position of the image to be printed, in a primary scanning direction by a difference between a reference center position of the print engine 10a and the actual sheet center position. In this embodiment, because the nozzles 11a of the recording heads 1a to 1d do not move, a nozzle corresponding to each pixel in the image to be printed is changed correspondingly to the depicting position of the image to be printed.

As mentioned, the control unit 81 determines nozzles 11a corresponding to the image to be printed (a nozzle 11a corresponding to each pixel), correspondingly to a position of a print sheet, and causes the recording heads 1a to 1d to eject ink from the determined nozzles 11a.

The correction processing unit 83 detects an ejection malfunction nozzle among the aforementioned nozzles 11a, and performs a correction process corresponding to the ejection malfunction nozzle.

For example, using the control unit 81, the correction processing unit 83 prints a test pattern (one-dot thin lines respectively corresponding to the nozzles 11a, a band along the primary scanning direction and/or the like) on a print sheet using the aforementioned recording heads 1a to 1d for each of the aforementioned plural ink colors, and determines an ejection malfunction nozzle and its ejection malfunction type (i.e. non ejection, ejection deviation and the like) on the basis of a scanned image of the test pattern.

Here, in accordance with an existent method, an ejection malfunction position is determined on the basis of a density distribution of the scanned image of the test pattern, and a nozzle 11a corresponding to the ejection malfunction position (i.e. a nozzle 11a that should eject ink at the ejection malfunction position) is determined as an ejection malfunction nozzle. “Ejection deviation” means a state that deviation of a hitting position of an ink droplet ejected from a nozzle 11a occurs in the primary scanning direction. Further, a scanned image of the test pattern is acquired using the line sensor 31 or the image scanning device 74. If the line sensor 31 scans an image of the test pattern, the print sheet on which the test pattern has been printed by the print engine 10a is transported to a position of the line sensor 31 using the circulation transportation unit 10b2.

Further, for example, in the correction process, within time from determination of a sheet position to ink ejection, the correction processing 83 (a) determines a pixel corresponding to an ejection malfunction nozzle in an image to be printed, and (b) performs density adjustment on the pixel and its adjacent pixels. For example, image data (pixel value) of a pixel corresponding to an ejection malfunction nozzle is corrected to a value of non ink ejection, and image data (pixel value) of a pixel adjacent to the ejection malfunction nozzle is corrected such that a density of this pixel is increased.

In this embodiment, regardless of an ejection malfunction type (ejection deviation, non ejection or the like) of the ejection malfunction nozzle, the correction processing unit 83 (a) sets the ejection malfunction nozzle as a non-ejection nozzle and (b) increases an ink droplet amount of a nozzle 11a corresponding to at least one of two adjacent dots of a dot position corresponding to the ejection malfunction nozzle set as a non-ejection nozzle.

Further, if the number of the detected ejection malfunction nozzles exceeds a predetermined upperlimit value (the number of nozzles 11a for which the aforementioned correction process can be performed within the aforementioned time), then the correction processing unit 83 preferentially sets as targets of the correction process ejection malfunction nozzles that eject ink droplets earlier than nozzles corresponding to the respective two adjacent dots (i.e. early ejection nozzles among the detected ejection malfunction nozzles). If the number of (all of) the detected ejection malfunction nozzles does not exceed the aforementioned predetermined upperlimit value, the correction process is performed for all of the detected ejection malfunction nozzles.

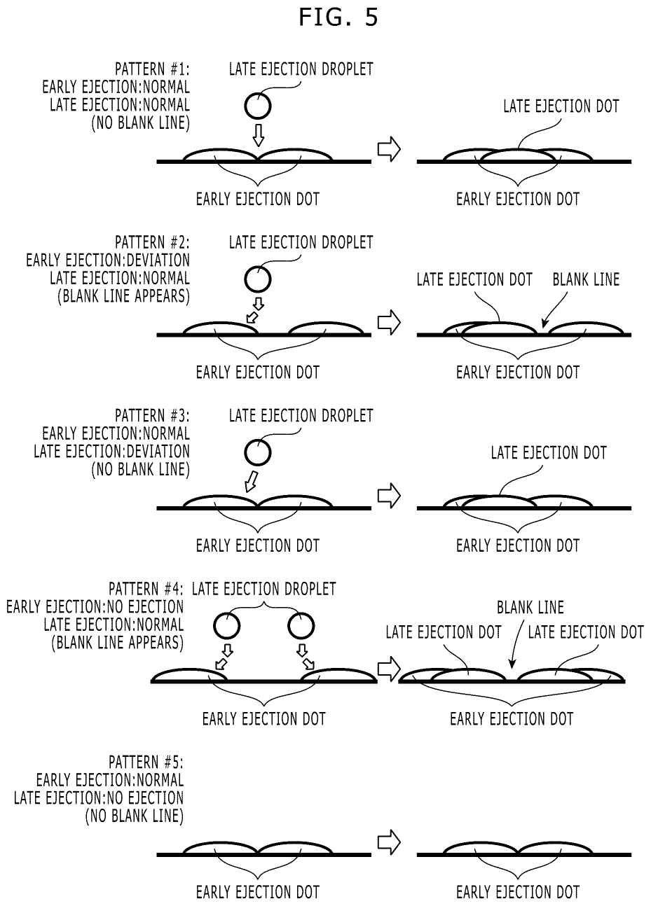

FIG. 5 shows a diagram that explains a difference of an occurrence degree of droplet coalescence due to ejection order. For example, as shown in FIG. 5, there are a case that ejection malfunction does not occur on any of the early ejection nozzles and the late ejection nozzles (PATTERN #1), cases that ejection malfunction occurs on the early ejection nozzles (PATTERNS #2 and #4), and cases that ejection malfunction occurs on the late ejection nozzles (PATTERNS #3 and #5). As shown in FIG. 5, if ejection malfunction does not occur on the early ejection nozzles, then a blank line (density defect) tends not to occur; and even if ejection malfunction does not occur on the late ejection nozzles but occurs on the early ejection nozzles, a position of the late ejection dot is shifted due to droplet coalescence and consequently a blank line (density defect) tends to occur. Therefore, in this embodiment, the ejection malfunction nozzles that are the early ejection nozzles are preferentially selected as targets of the correction process.

Further, in this embodiment, in particular, if the number of the detected ejection malfunction nozzles exceeds the predetermined upperlimit value, the correction processing unit 83 (a) sets as a primary preference nozzle an ejection malfunction nozzle that ejects an ink droplet earlier than nozzles 11a corresponding to the aforementioned two adjacent dots (i.e. a target nozzle in the aforementioned Ejection order #1), (b) sets as a secondary preference nozzle an ejection malfunction nozzle that ejects an ink droplet earlier than one of nozzles corresponding to the aforementioned two adjacent dots but ejects an ink droplet later than the other of nozzles corresponding to the two adjacent dots (i.e. a target nozzle in the aforementioned Ejection order #3), and (c) sets the primary preference nozzle and the secondary preference nozzle as targets of the correction process in an order of the primary preference nozzle, the secondary preference nozzle.

Therefore, if the number of the primary preference nozzles is equal to or less than the aforementioned predetermined upperlimit value, then all of the primary preference nozzles are set as targets of the correction process. Further, if the number of the primary preference nozzles is less than the aforementioned predetermined upperlimit value, then all of the primary preference nozzles are set as targets of the correction process and a part or all of the secondary preference nozzles are set as targets of the correction process.

Furthermore, if the number of the primary and secondary preference nozzles is equal to or less than the aforementioned predetermined upperlimit value, then all of the primary and secondary preference nozzles are set as targets of the correction process. Further, if the number of the primary and secondary preference nozzles is less than the aforementioned predetermined upperlimit value, then all of the primary and secondary preference nozzles are set as targets of the correction process and a part or all of remaining ejection malfunction nozzles are set as targets of the correction process.

Furthermore, in this embodiment, if the number of ejection malfunction nozzles that eject ink droplet earlier than nozzles corresponding to the respective aforementioned two adjacent dots (i.e. the number of ejection malfunction nozzles that are early ejection nozzles) exceeds the aforementioned upperlimit value, then the correction processing unit 83 selects as targets of the correction process ejection malfunction nozzles that eject ink droplets earlier than nozzles corresponding to the respective two adjacent dots on the basis of their ejection malfunction types and/or degrees of ejection malfunction (a deviation amount of ejection deviation or the like) such that the number of the selected ejection malfunction nozzles is equal to or less than the predetermined upperlimit value among ejection malfunction nozzles that are early ejection nozzles. For example, among ejection malfunction nozzles that are early ejection nozzles, an ejection malfunction nozzle of non ejection is more preferentially selected than an ejection malfunction nozzle of ejection deviation.

Furthermore, in this embodiment, an increasing amount of the ink droplet amount of an ejection malfunction nozzle is set such that the increasing amount is changed correspondingly to an ink droplet ejection order between this ejection malfunction nozzle and the two adjacent dots. For example, in a case of the aforementioned Ejection order #2, the increasing amount is set so as to be smaller than the increasing amounts in the aforementioned ejection orders #1 and #3.

The following part explains a behavior of the image forming apparatus 10.

### (a) Setting of an Ejection Malfunction Nozzle as a Target of the Correction Process

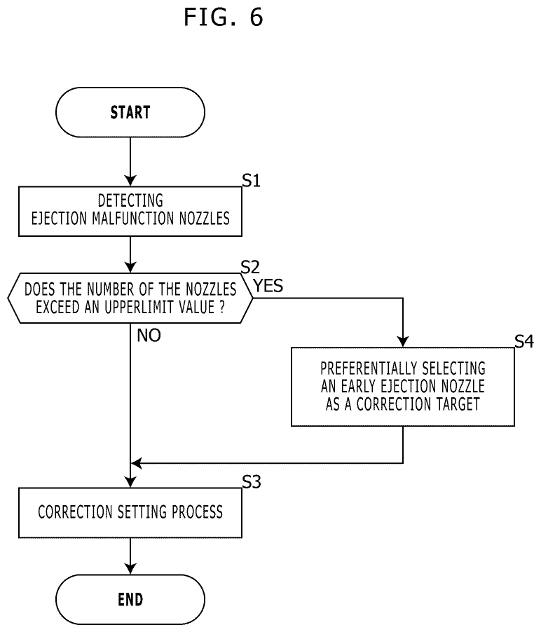

FIG. 6 shows a flowchart that explains a setting of an ejection malfunction nozzle as a target of a correction process in the image forming apparatus 10 shown in FIGS. 1 to 3.

The correction processing unit 83 detects current ejection malfunction nozzles (in Step S1). Specifically, using the control unit 81, the correction processing unit 83 causes the image outputting unit 71 to print to a print sheet a test pattern to determine an ejection malfunction nozzle. The correction processing unit 83 acquires a scanned image (i.e. image data of each ink color) of the test pattern using the line sensor 31 or the image scanning device 74 as mentioned. On the basis of a primary-scanning-directional density distribution of the scanned image of the test pattern, the correction processing unit 83 determines an ejection malfunction nozzle from an ejection malfunction position (a position that density defect occurs) in the density distribution.

Subsequently, the correction processing unit 83 determines whether the number of the detected ejection malfunction nozzles exceeds a predetermined upperlimit value or not (in Step S2).

If the number of the detected ejection malfunction nozzles does not exceed the predetermined upperlimit value, then the correction processing unit 83 sets all of the detected ejection malfunction nozzles as targets of the correction process, and stores ejection malfunction data that indicates the ejection malfunction nozzles as the targets of the correction process (their nozzle numbers or the like) into the storage device (in Step S3).

Otherwise, if the number of the detected ejection malfunction nozzles exceeds the predetermined upperlimit value, then the correction processing unit 83 selects targets of the correction process among the detected ejection malfunction nozzles such that early ejection nozzles are preferentially selected and the number of the selected ejection malfunction nozzles is equal to or less than the predetermined upperlimit value (in Step S4). Afterward, the correction processing unit 83 sets the selected ejection malfunction nozzles as targets of the correction process, and stores ejection malfunction data that indicates the ejection malfunction nozzles as the targets of the correction process (their nozzle numbers or the like) into the storage device (in Step S3).

As mentioned, an ink ejection malfunction nozzle is set as a target of the correction process.

### (b) Behavior for Printing

When receiving a print request, the control unit 81 causes the image processing unit 82 to perform an image process for an image specified by the print request, and thereby acquires image data of the image to be printed; and causes the image outputting unit 71 to transport a print sheet and print the image to be printed on the print sheet on the basis of the image data.

In this process, the correction processing unit 83 reads the ejection malfunction data from the storage device 73 prior to start of the printing, and determines ejection malfunction nozzles as targets of the correction process. Upon detecting a position of the print sheet by the line sensor 31, the correction processing unit 83 (a) determines a nozzle 11a corresponding to each pixel in the aforementioned image and (b) performs the correction process for each of the ejection malfunction nozzles among the nozzles 11a used for the aforementioned image. Consequently, in this image, the correction process is performed for a part corresponding to the ejection malfunction nozzles as targets of the correction process and its adjacent nozzles. Subsequently, the control unit 81 performs the aforementioned printing on the basis of the image data after the correction process.

As mentioned, in the aforementioned embodiment, the correction processing unit 83 detects an ejection malfunction nozzle among nozzles 11a in the recording heads 1a to 1d, and performs a correction process corresponding to the ejection malfunction nozzle. In particular, if the number of the detected ejection malfunction nozzles exceeds a predetermined upperlimit value, the correction processing unit 83 preferentially sets as a target of the correction process an ejection malfunction nozzle that ejects an ink droplet earlier than nozzles 11a corresponding to two adjacent dots of a dot corresponding to the ejection malfunction nozzle.

Consequently, ejection malfunction nozzles that strongly affect image quality are preferentially set as targets of the correction process, and therefore, the correction process against ejection malfunction is properly performed. In particular, when a print sheet of low ink absorption such as coated paper sheet or label paper sheet is used, ink droplet coalescence becomes noticeable, but the correction process restrains image quality degradation due to ejection malfunction.

For example, in a case that a nozzle resolution of the recording heads 1a to 1d is 1200 dpi, the upperlimit value of the number of nozzles as targets of the correction process is 100, the number of nozzles 11a in a nozzle array 11b-i is 6643, the total number of the ejection malfunction nozzles is 183 (the number of ejection malfunction nozzles in Ejection order #1 is 96, the number of ejection malfunction nozzles in Ejection order #3 is 8 and the number of ejection malfunction nozzles in Ejection order #2 is 79), (a) when ejection malfunction nozzles in Ejection order #1 were preferentially selected as targets of the correction process, eight blank lines (density defect positions) were visually confirmed, but (b) when ejection malfunction nozzles were selected as targets of the correction process in turn from left toward right, 55 blank lines ware visually confirmed. Therefore, this embodiment provides favorable image quality.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

What is claimed is:

1. An image forming apparatus, comprising:
a recording head configured to eject ink corresponding to an image to be printed, using arranged nozzles;
a control unit configured to determine nozzles corresponding to the image to be printed, correspondingly to a position of a print sheet, and cause the recording head to eject ink from the nozzles;
a correction processing unit configured to detect an ejection malfunction nozzle and perform a correction process corresponding to the ejection malfunction nozzles;
wherein if the number of the detected ejection malfunction nozzles exceeds a predetermined upperlimit value, the correction processing unit preferentially sets as a target of the correction process an ejection malfunction nozzle that ejects an ink droplet earlier than nozzles corresponding to two adjacent dots of a dot corresponding to the ejection malfunction nozzle.

2. The image forming apparatus according to claim 1, wherein if the number of the detected ejection malfunction nozzles exceeds the predetermined upperlimit value, the correction processing unit (a) sets as a primary preference nozzle an ejection malfunction nozzle that ejects an ink droplet earlier than nozzles corresponding to the two adjacent dots, (b) sets as a secondary preference nozzle an ejection malfunction nozzle that ejects an ink droplet earlier than one of nozzles corresponding to the two adjacent dots but ejects an ink droplet later than the other of nozzles corresponding to the two adjacent dots, and (c) sets the primary preference nozzle and the secondary preference nozzle as targets of the correction process in an order of the primary preference nozzle, the secondary preference nozzle.

3. The image forming apparatus according to claim 1, wherein if the number of the ejection malfunction nozzles that ejects an ink droplet earlier than nozzles corresponding to the two adjacent dots exceeds a predetermined upperlimit value, the correction processing unit selects as targets of the correction process the ejection malfunction nozzles that eject ink droplets earlier than nozzles corresponding to the respective two adjacent dots such that the number of the selected ejection malfunction nozzles is equal to or less than the predetermined upperlimit value among the ejection malfunction nozzles that eject an ink droplet earlier than nozzles corresponding to the respective two adjacent dots.

4. The image forming apparatus according to claim 1, wherein regardless of an ejection malfunction type of the ejection malfunction nozzle, the correction processing unit (a) sets the ejection malfunction nozzle as a non-ejection nozzle and (b) increases an ink droplet amount of a nozzle corresponding to at least one of the two adjacent dots.

5. The image forming apparatus according to claim 4, wherein an increasing amount of the ink droplet of this ejection malfunction nozzle is set such that the increasing amount is changed correspondingly to an ink droplet ejection order between this ejection malfunction nozzle and the two adjacent dots.
